(19) United States
(12) Patent Application Publication
(10) Pub. No.: US 2004/0040348 A1
(43) Pub. Date: Mar. 4, 2004

(54) Padlock with identification means

(76) Inventor: Renny Tse-Haw Ling, Chung-Ho City (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/234,898

(22) Filed: Sep. 4, 2002

(51) Int. Cl. E05B 67/02

(52) U.S. Cl. 70/52

(57) ABSTRACT

This invention is related to a padlock with identification means, comprising: a padlock body, having a visible surface and a fastening means provided on the visible surface; a shackle to be selectively locked to or unlocked from the padlock body; and an identification means, configured to conform to the visible surface of the padlock body and having a mating means for detachably mating with the fastening means of the padlock body, the identification means stretching over at least part of the visible surface.

### FIELD OF INVENTION

This invention is related to a padlock with identification means, in particular to one have an identification means that is detachable from the padlock, at desire, such that the identification means may serve to assist a user in identifying the article that the padlock is shackled to.

### BACKGROUND OF INVENTION

Once a plurality of identical padlocks each equipped with a shackle having one long leg and one short leg are shackled to a plurality of identical or similar articles, it is relatively difficult for the user to identify a specific article among the plurality of identical articles. Further, it is sometimes necessary to use padlocks each of a certain appearance to distinguish a group of articles from another group.

One may to distinguish the different padlocks is to use different padlocks, such as of different, innate configurations or appearance. However, it may be complicated for the user if padlocks of different specifications are used.

### SUMMARY OF INVENTION

It is therefore among the objects of the invention to provide a padlock with identification means, such that in applications, the identification means serves to assist a user in identifying the article which the padlock is shackled to.

According to an embodiment of this invention, the identification means may be easily viewed by the user and is detachable from the padlock such that a single padlock may be used repetitively to serve different identification purposes.

With these and other objects in view, the invention consists in the construction, arrangement, and combination of the various parts of the device, whereby the objects contemplated are attained, as hereinafter set forth, pointed out in the appended claims and illustrated in the accompanying drawings.

### IN THE DRAWINGS

FIG. 1 is a perspective view showing an embodiment of this invention;

FIG. 2 is an exploded view of the embodiment of FIG. 1;

FIG. 3 is an elevational view of a padlock of this invention partially broken away to show an embodiment of the fastening and mating means;

FIG. 4 is an elevational view of a padlock of this invention partially broken away to show an alternative embodiment of the fastening and mating means;

FIG. 5 is a perspective view showing an alternative embodiment of this invention;

FIG. 6 is an exploded view of the embodiment of FIG. 5;

FIG. 7 is an elevational view of a padlock of this invention partially broken away to show an embodiment of the fastening and mating means in the padlock of FIG. 5;

FIG. 8 is a perspective view showing a further embodiment of this invention;

FIG. 9 is an exploded view of the embodiment of FIG. 8; and

FIG. 10 is an elevational view of a padlock of this invention partially broken away to show an embodiment of the fastening and mating means in the padlock of FIG. 8.

### DETAILED DESCRIPTIONS OF EMBODIMENTS

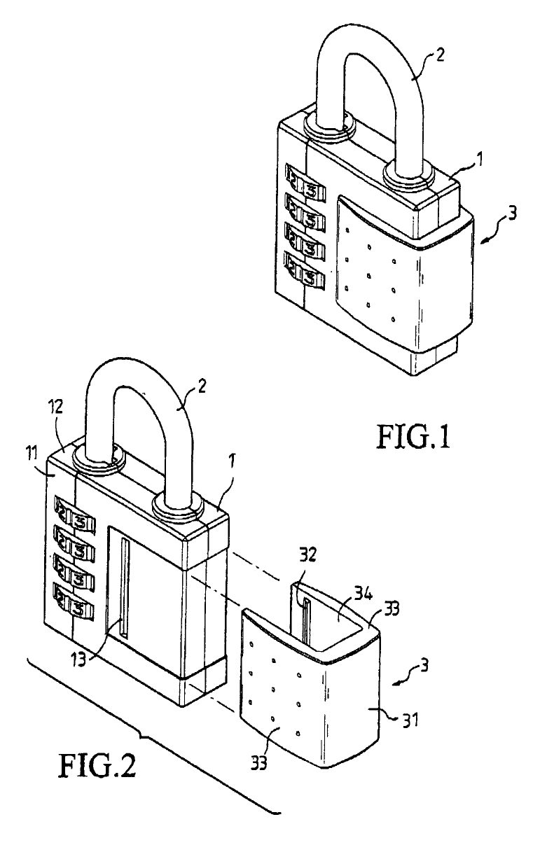

To achieve the intended objects of this invention, an embodiment for a padlock with an identification means is disclosed in FIGS. 1 and 2, in which the padlock comprises a padlock body 1 and a shackle 2. The padlock body 1 has a visible surface 10 and a fastening means 13 provided on the visible surface 10.

To feature the padlock with Identification function, this invention provides an identification means 3 that is configured to conform to the visible surface 10 of the padlock body 1 and includes a mating means 32 for detachably mating with the fastening means 13 of the padlock body 1, wherein the identification means 3 stretches over at least part of the visible surface 10.

In this embodiment where the padlock body 1 being a rectangular shape, the visible surface 10 is constructed of a plurality of sub-faces, including two main surfaces 11 (one of them not shown) opposing one another, and a peripheral surface 12 bordering the main surfaces 11. The peripheral surface 19 includes a top, a bottom, and two opposing sides. The shackle 2 is provided on the top to be selectively locked to or unlocked from the padlock body 1, and the identification means 3 at least stretches from one of the main surfaces 11 to the other main surface by continuing through the peripheral surface 12.

The visible surface 10 may also be constructed of difference sub-faces depending on the shape of the padlock body 1. For example, in the case where the padlock body 1 is of a sphere, the visible surface 10 will then be an integral spherical surface; in case the padlock body 1 of a pyramid, the visible surface will then be four adjacent triangular face placed on a top of a rectangular face.

Regardless of the shape, the identification means 3 is preferably conformed to the visible surface 10 of the padlock body 1, such that after the identification means 3 may be easily attached to the padlock body 1. Further, the identification means 3 is preferably visible from different viewing angles once it is attached to the padlock body 1 to ensure the visibility of the identification means 3 such that the user may easily view the identification means 3 from a distance.

Based on the embodiment of FIGS. 1 and 2, to conform to the rectangular shape of the padlock body 1, the identification means 3 includes a generally U-shaped block having a base 31, two flanges 33 protruding form the base 31, and an inner face 35 facing the padlock body 1. The U-shaped block is attached to the padlock body 1 with the base 31 urging against the peripheral surface 12 and the flanges 33 each covering part of the main surfaces 11.

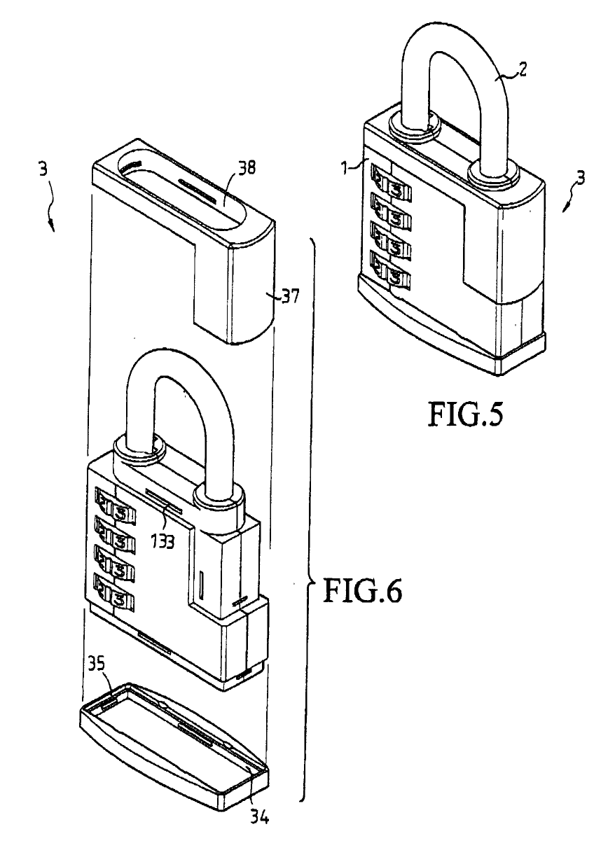

In an alternative embodiment as shown in FIGS. 5 and 6, two types of identification means 3 are illustrated. One of the identification means 3 includes an O-shaped block 34 having an inner face 35 facing the padlock body 1. Another identification means 3 includes an O-shaped block 36 further provided with a protruding ledge 37 protruding from the block 36 in addition to an inner face 38 facing the padlock body 1.

Both types of identification means 3 are attached to the padlock body 1 with the block 34, 36 urging against the peripheral surface 12, and the block 34, 36 and/or the protruding ledge 37 covering part of the main surfaces 11. Noting that only one type of identification means 3 is required to be attached to the padlock body 1 so as to feature the padlock body 1 with the intended identification purpose.

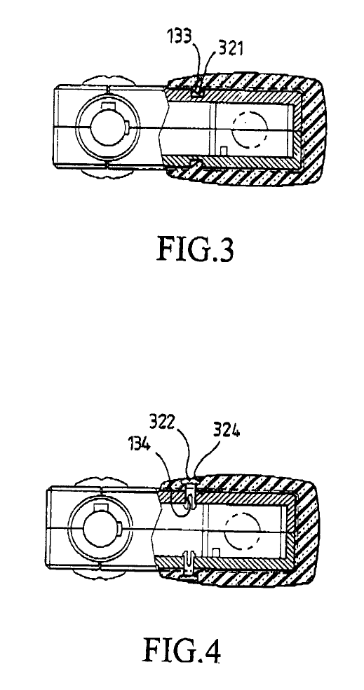

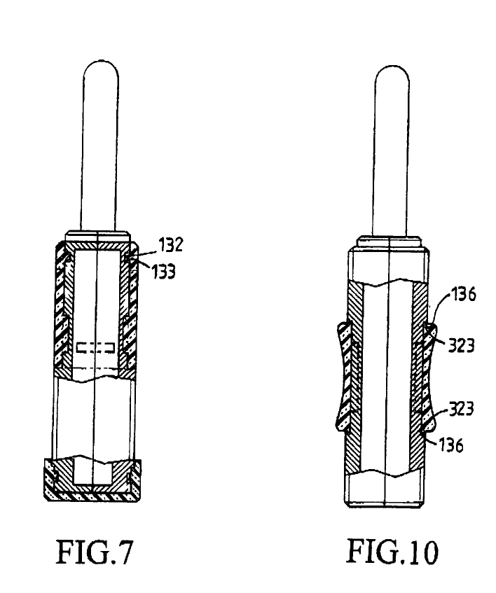

According to the embodiment shown in FIGS. 3 and 7, the fastening means 13 includes notches 133 formed on each of the main surfaces 11 of the padlock body 1, and the mating means 32 includes lips 321 complimentary to the notches 133 and protruding from the inner face 35 of the identification means 3 at locations corresponding to the notches 133 of the fastening means 13.

The complimentary structure of notches and lips may be reversed such that the lips protrude from each of the main surfaces, and the notches are formed on the inner face of the identification means at locations corresponding to the lips.

In a further embodiment shown in FIG. 4, the fastening means 13 includes holes 134 formed an each of the main surfaces 11 of the padlock body 1, and the mating means 32 includes holes 324 formed on the identification means 3 at locations corresponding to the holes 134 of the fastening means 13, and pegs 322 inserting through the holes 134, 324 of the identification means 13 and the fastening means 32.

In these embodiments, the identification means 31 is preferably made of resilient materials such that it may be expanded and then snap to fit the padlock body 1 by engaging the fastening means 13 to the mating means 32.

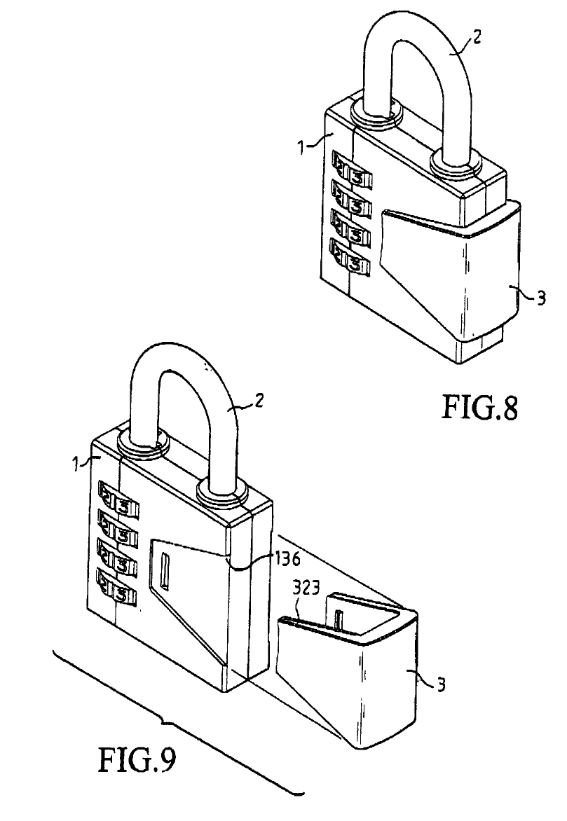

In a further embodiment shown in FIGS. 8-10, the fastening means 13 includes a pair of dovetail grooves 136 formed at least one of the main surfaces 11 of the padlock body 1, and the mating means 32 includes dovetail edges 323 complimentary to the dovetail grooves 136 and formed along the identification means 31.

In this embodiment, the identification means 13 may be slid unto the padlock body 1 by engaging the dovetail edges 323 to the dovetail groove 136.

In any of the above embodiments, the notches, lips, holes, dovetail grooves may only be formed on one of the sub-faces of the visible surface 10, according to the desired appearance of the padlock.

It should also be noted that, a great variety of fastening and mating means might be adopted, in addition to those that have been described above, so long as they may provide the desired detachable function.

To further enhance the diversity of the padlock, one padlock may be sold with a number of identification means having various colors, such that the user may replace the identification means at desire.

Aforementioned explanation is directed to the description of the preferred embodiment according to the present invention. Various changes and implementations can be made by those skilled in the art without departing from the technical concept of the present invention. Since the present invention is not limited to the specific details described in connection with the preferred embodiment except those that may be within the scope of the appended claims, changes to certain features of the preferred embodiment without altering the overall basic function of the invention are contemplated.

LIST OF REFERENCE NUMERALS

| | |
|---|---|
| 1 | padlock body |
| 2 | shackle |
| 3 | identification means |
| 10 | visible surface |
| 11 | main surfaces |
| 13 | fastening means |
| 31 | base |
| 32 | mating means |
| 33 | flanges |
| 34 | O-shaped block |
| 35 | inner face |
| 36 | O-shaped block |
| 37 | protruding ledge |
| 38 | inner face |
| 133 | notches |
| 134 | holes |
| 136 | dovetail grooves |
| 321 | lips |
| 322 | pegs |
| 323 | dovetail edges |
| 324 | holes |

What is claimed is:

1. A padlock with identification means, comprising:
a padlock body, having a visible surface and a fastening means provided on the visible surface;
a shackle to be selectively locked to or unlocked from the padlock body; and
an identification means, configured to conform to the visible surface of the padlock body and having a mating means for detachably mating with the fastening means of the padlock body, the identification means stretching over at least part of the visible surface.

2. The padlock with identification means according to claim 1, wherein the padlock body is of a spherical shape and the visible surface comprises an integral spherical surface.

3. The padlock with identification means according to claim 1, wherein the padlock body of a pyramid shape, and the visible surface comprises four adjacent triangular face placed on a top of a rectangular face.

4. The padlock with identification means according to claim 1, wherein the padlock body is of a rectangular shape and the visible surface comprises two main surfaces opposing one another, and a peripheral surface bordering the main surfaces, the peripheral surface including a top, a bottom, and two opposing sides, the shackle being provided on the top side of the peripheral surface.

5. The padlock with identification means according to claim 4, wherein the identification means at least stretches from one of the main surfaces to the other main surface by continuing through the peripheral surface.

6. The padlock with identification means according to claim 4, wherein the identification means includes a generally U-shaped block having a base, two flanges protruding form the base, and an inner face facing the padlock body, the U-shaped block being attached to the padlock body with the base urging against the peripheral surface and the flanges each covering part of the main surfaces.

7. The padlock with identification means according to claim 6, wherein the fastening means includes notches formed on each of the main surfaces of the padlock body, and the mating means includes lips complimentary to the notches and protruding from the inner face of the identification means at locations corresponding to the notches of the fastening means.

8. The padlock with identification means according to claim 6, wherein the fastening means includes lips protruding from each of the main surfaces of the padlock body, and the mating means includes notches complimentary to the lips and formed on the inner face of the identification means at locations corresponding to the lips of the fastening means.

9. The padlock with identification means according to claim 6, wherein the fastening means includes holes formed on each of the main surfaces of the padlock body, and the mating means includes holes formed on the identification means at locations corresponding to the holes of the fastening means, and pegs inserting through the holes of the identification means and the fastening means.

10. The padlock with identification means according to claim 6, wherein the fastening means includes a pair of dovetail grooves formed at least one of the main surfaces of the padlock body, and the mating means includes dovetail edges complimentary to the dovetail grooves and formed along the identification means at locations corresponding to the dovetail grooves of the fastening means.

11. The padlock with identification means according to claim 4, wherein the identification means includes an O-shaped block having a protruding ledge protruding from the block, and an inner face facing the padlock body, the O-shaped block being attached to the padlock body with the block urging against the peripheral surface and the protruding ledge covering part of the main surfaces.

12. The padlock with identification means according to claim 11, wherein the fastening means includes notches formed on each of the main surfaces of the padlock body, and the mating means includes lips complimentary to the notches and protruding from the inner face of the identification means at locations corresponding to the notches of the fastening means.

13. The padlock with identification means according to claim 11, wherein the fastening means includes lips protruding from each of the main surfaces of the padlock body, and the mating means includes notches complimentary to the lips and formed on the inner face of the identification means at locations corresponding to the lips of the fastening means.

14. The padlock with identification means according to claim 11, wherein the fastening means includes holes formed on each of the main surfaces of the padlock body, and the mating means includes holes formed on the identification means at locations corresponding to the holes of the fastening means, and pegs inserting through the holes of the identification means and the fastening means.

15. The padlock with identification means according to claim 11, wherein the fastening means includes a pair of dovetail grooves formed at least one of the main surfaces of the padlock body, and the mating means includes dovetail edges complimentary to the dovetail grooves and formed along the identification means at locations corresponding to the dovetail grooves of the fastening means.

16. The padlock with identification means according to claim 11, wherein the identification means is attached to a bottom of the padlock body.

17. The padlock with identification means according to claim 11, wherein the identification means is attached to the top the padlock body by passing through the shackle by passing through the shackle.

18. The padlock with identification means according to claim 11, wherein the identification means is attached to either of the opposing sides of the padlock body.

19. The padlock with identification means according to claim 1, wherein the identification means is of various colors.

20. The padlock with identification means according to claim 1, wherein the identification means is made by injection molding.
